(19) United States
(12) Patent Application Publication
(10) Pub. No.: US 2009/0304895 A1
(43) Pub. Date: Dec. 10, 2009

(54) PROCESS FOR PREPARING A TEA BEVERAGE

(75) Inventors: Venkatraj Venkatrao Narayanan, Bangalore (IN); Vilas Pandurang Sinkar, Bangalore (IN)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/478,833

(22) Filed: Jun. 5, 2009

(30) Foreign Application Priority Data
Jun. 10, 2008 (IN) 1226/MUM/2008
Jul. 29, 2008 (EP) EP08161354

(51) Int. Cl. A23F 3/16; A23F 3/06

(52) U.S. Cl. 426/597; 426/422

(57) ABSTRACT

A process is disclosed for preparation of a ready-to-drink tea beverage. The beverage comprises an aqueous acidulant constituent having pH less than 4 and an aqueous non-acidulant constituent having pH greater than 4, the aqueous non-acidulant constituent comprises a flavourant, and at least one of the constituents comprises cold-soluble tea solids. The process comprises the steps of: subjecting each of the constituents separately to pasteurization; cooling each of the constituents separately to a temperature less than 75° C.; and mixing the constituents.

### TECHNICAL FIELD

The invention relates to the field of ready-to-drink tea beverages.

### BACKGROUND AND PRIOR ART

Any discussion of the prior art throughout the specification should in no way be considered as an admission that such prior art is widely known or forms part of the common general knowledge in the field.

Consumption of tea, a beverage that refreshes whilst giving several health benefits, is rising as consumers are becoming increasingly health-conscious. One of the popular forms of tea is the so called ready-to-drink (RTD) tea beverage, which can be conveniently carried in cans/bottles and consumed without need for brewing/infusion.

A typical process of preparation of a ready-to-drink beverage comprises a step of mixing all the ingredients followed by a step of pasteurization or heat treatment to meet microbial safety norms. The ingredients of ready-to-drink tea beverages usually include water, cold-soluble tea solids, flavourants and/or acidulants. Flavourants are added to ready-to-drink tea beverages to improve taste, flavour and aroma. An acidulant such as citric acid is also added to the ready-to-drink beverage, which not only lowers pH but also acts as a taste enhancer.

The ready-to-drink beverage prepared by the conventional process suffers from problem of loss of aroma and/or flavour. It is possible to add chemical preservatives or agents to beverages that obviate the need of heat treatment. However, beverages with added preservatives are becoming increasingly unacceptable to consumers.

Thus there is an ongoing need for ready-to-drink tea beverages that preserve aroma and/or flavour after the heat treatment.

One of the objects of the present invention is to provide a process for preparation of a ready-to-drink tea beverage that is subjected to heat treatment or pasteurization and yet has relatively stable aroma and/or taste.

Another object of the present invention is to provide a process for preparation of a ready-to-drink beverage that has relatively longer shelf-stability with relatively less loss of aroma and/or flavour.

The present inventors have surprisingly found that a ready-to-drink tea beverage that retains its aroma and has a relatively long shelf life can be prepared by separately pasteurizing and cooling the acidulant constituent and non-acidulant constituent prior to mixing.

### SUMMARY OF THE INVENTION

According to the present invention there is provided a process for preparation of a ready-to-drink tea beverage, wherein the beverage comprises an aqueous acidulant constituent having pH less than 4 and an aqueous non-acidulant constituent having pH greater than 4, the aqueous non-acidulant constituent comprises a flavourant, and at least one of the constituents comprises cold-soluble tea solids, and the process comprises the steps of:
a. subjecting each of the constituents separately to pasteurization;
b. cooling each of the constituents separately to a temperature less than 75° C.; and
c. mixing the constituents.

According to another aspect, there is provided a ready-to-drink tea beverage obtained or obtainable according to the process of the present invention.

All pH values are determined at 25° C. unless otherwise stated.

### DETAILED DESCRIPTION OF THE INVENTION

### Aqueous Acidulant Constituent

The aqueous acidulant constituent has pH less than 4, more preferably less than 3.5, and most preferably less than 3. The aqueous acidulant constituent comprises water and an acid or salt or ester thereof. Any acid that has pKa less than 5 can be used. Alternatively a salt or ester of an acid can be used provided that the salt or the ester has pKa less than 5. Accordingly, the acid, or salt or ester thereof has pKa less than 5, more preferably less than 4.5 and most preferably less than 4. In the case of polyprotic acid, the term pKa refers to the first pKa. Any food-grade acid that meets the requirement of pKa can be used according to the present invention. The acid is preferably selected from a group consisting of formic acid (pKa 3.15), acetic acid (pKa 4.7.6), citric acid (pKa1 3.13), ascorbic acid (pKa1 4.10), fumaric acid (pKa1 3.03), succinic acid (pKa1 4.16), lactic acid (pKa 3.08), malic acid (pKa1 3.40), phosphoric acid (pKa1 2.15), L-tartaric acid (pKa1 2.98) or a mixture thereof. Salts or esters of above acids, that have pKa less than 5 can also be used. It is particularly preferred that the acid is citric acid or a salt thereof. Salts of citric acid such as its mono-sodium salt can be preferably used. Any other salts or esters having pKa less than 5 can be used. One non-limiting example of the salt that can be used includes sodium bisulfate (pKa 1.9).

### Aqueous Non-Acidulant Constituent

The aqueous non-acidulant constituent has pH greater than 4, more preferably greater than 4.5 and most preferably greater than 5. The aqueous non-acidulant constituent comprises water and a flavourant. The flavourant is preferably an acid-degradable flavourant. The term acid degradable flavourant as used herein means a food flavour ingredient that generates an off-flavour when subjected to pH of less than 4 at a temperature greater than 35° C.

The acid-degradable flavourant may be natural or synthetic. The acid degradable flavourant preferably comprises a terpene alcohol. Terpene alcohols are typically found in most fruits and flowers in nature and exhibit several shades of pleasant odour profiles which are usually classified as ‘floral’.

According to a further preferred aspect, the terpene alcohol is selected from the group consisting of linalool, nerol, geraniol or a mixture thereof. It is particularly preferred that the terpene alcohol is linalool. Natural tea aroma, obtained by recovering volatiles during manufacture of tea, particularly black tea, comprises terpene alcohols, in particular, linalool. Natural tea aroma comprises from 50 ppm to 25000 ppm terpene alcohols. Accordingly, it is envisaged that the natural tea aroma can itself be used as an acid degradable flavourant.

### Step of Pasteurization

The process involves a step of subjecting each of the constituents separately to pasteurization. The term pasteurization as used herein includes all heat treatments used for logarithmic reduction or elimination of microorganisms. Accordingly, the term pasteurization includes Extended Shelf Life (ESL) treatment, High Temperature Short Time (HTST) treatment and Ultra-High Temperature (UHT) treatment also known as Ultra-pasteurization. Pasteurization is preferably carried out by maintaining the constituent at a temperature between 60° C. to 150° C. for duration between 5 seconds to 60 minutes. When the temperature is high, the duration of treatment is low and vice versa.

### The Step of Cooling

The present inventors have determined that constituents need to be pasteurized separately and then cooled separately to temperature less than 75° C. prior to mixing to prepare the ready-to-drink tea beverage. The process according to the present invention comprises a step of cooling the constituents separately to a temperature less than 75° C., after pasteurization and before mixing. The constituents are cooled to temperature preferably less than 75° C., more preferably less than 55° C. and most preferably less than 40° C. Without wishing to be bound by theory, it is believed that the contact of the aqueous acidulant constituent with the aqueous non-acidulant constituent at high temperature causes generation of off-flavours and avoiding contact between the two constituents at elevated temperature is key to the reduction in generation of off-flavours.

### The Step of Mixing

The aqueous acidulant constituent and the aqueous non-acidulant constituent are mixed after each constituent has been separately subjected to a step of pasteurization and cooling to temperature of less than 75° C. It is possible to mix the ingredients in a separate vessel provided with a stirrer. However, it is preferred that the two constituents are filled in a container (such as a can or bottle) either simultaneously or sequentially, in any order, with the mixing action being provided during the filling operation. The mixing provided during filling is sufficient. After filling the two constituents, the container is sealed.

### Ready-to-Drink Tea Beverage

Ready-to-drink tea beverage comprises an aqueous acidulant constituent and an aqueous non-acidulant constituent. The mass ratio of the aqueus non-acidulant constituent to the aqueous acidulant constituent is preferably from 0.1:99.9 to 99.9:0.1, more preferably from 1:10 to 10:1, and most preferably from 1:5 to 5:1.

The ready-to-drink tea beverage comprises cold-soluble tea solids. At least one of the constituents comprises cold-soluble tea solids. The term cold-soluble tea solids as used herein refers to water-soluble tea-solids obtained from infusion of black tea, green tea or oolong tea after separating insoluble solids. The infusion may be carried out at temperature less than 40° C. Alternatively, the infusion may be carried out at higher temperature followed by cooling and decreaming or solubilizing of cream by alkali treatment. The infusion of cold-soluble tea solids may then be concentrated to obtain cold-soluble tea solids.

### Composition of the Ready-To-Drink Tea Beverage

The ready-to-drink tea beverage comprises preferably from 85% to 99% by weight water, more preferably from 90 to 95%. The acid or salt or ester thereof is preferably from 0.05% to 1%, more preferably from 0.1% to 0.5%, and most preferably from 0.15% to 0.3% by weight of the tea beverage. The flavourant is preferably from 0.001% to 0.1%, more preferably from 0.005% to 0.05%, and most preferably from 0.1% to 0.4% by weight of the tea beverage. The cold-soluble tea solids are preferably from 0.05% to 0.4%, more preferably from 0.05% to 0.3%, more preferably from 0.1% to 0.25%, by weight of the tea beverage.

### Other Ingredients

The ready-to-drink tea beverage may further comprise a preservative, a sweetener and other commonly used ingredients. Preservatives like sorbic acid and benzoic acid can be used in amounts not exceeding 300 and 150 ppm respectively. Natural and artificial sweeteners can be used. Natural sweeteners that can be used include sugars such as sucrose, glucose and fructose. Preferably at least one of the constituents comprises sugar. The amount of sugar is preferably from 2% to 20%, more preferably 5% to 16% and most preferably from 7% to 12% by weight of the beverage composition.

### EXAMPLES

The invention will now be demonstrated with examples. The examples are by way of illustration only and do not limit the scope of the invention in any manner.

### Materials and Methods

### Materials:

The model aroma volatiles linalool, nerol and geranaiol were purchased from Sigma-Aldrich Chemicals Company as food grade chemicals. The α-terpeniol that was used was chemical grade. Ethanol and propylene glycol were obtained from Merck. Cold-soluble tea solids were obtained from black tea originating from tea gardens in South India.

### Methods:

### Preparation of a Ready-To-Drink Tea Beverage

Comparative Example A: Tea powder was obtained from tea fibres originating from Kenya. Sugar (85 g), ascorbic acid (0.2 g), citric acid (2.0 g) and tea powder (2.2 g) were stirred in distilled water (450 mL) until a clear solution was obtained. Distilled water was then added to make the final volume of the tea beverage to 1000 mL. 4 mL of linalool stock solution (2000 ppm in propylene glycol) was added to the tea beverage. The concentration of linalool was 8 ppm of the tea beverage. The tea beverage was then filled in 250 mL glass bottles, capped tightly and pasteurized according to the procedure given below.

### Pasteurization Procedure:

The capped ready-to-drink tea bottles were heated in a controlled temperature hot water bath. The heating was done over a period of one hour and once the temperature reached 85-90° C. it was maintained for 30 minutes. The bottles, after removing from the bath, were kept under ambient conditions (room temperature of about 23° C.) for a period of an hour. At the end of this period, the beverage temperature was measured and found to be 25° C.

### Example 1

### Aqueous Acidulant Constituent

The aqueous acidulant constituent was prepared by mixing the following:

| | | |
|---|---|---|
| Water | 500 | mL |
| Citric acid | 2 | g |
| Ascorbic acid | 0.2 | g |
| Sugar | 85 | g |
| Cold Soluble Tea Solids | 2.2 | g |

After adding all the ingredients, pH of the aqueous acidulant constituent was measured and found to be 3.

### Aqueous Non-Acidulant Constituent:

4 mL of linalool stock solution (2000 ppm in propylene glycol) was added to 500 mL distilled water to prepare the aqueous non-acidulant constituent. pH of the aqueous non-acidulant constituent was measured and found to be 7.

The two constituents were separately pasteurized according to the procedure described earlier. After pasteurization the constituents were cooled to 25° C. The two constituents were then mixed together to prepare ready-to-drink tea beverage.

### Head-Space Gas Chromatography

Vials containing the beverage samples were capped and headspace sample analysis was performed using a PERKIN ELMER™ Headspace Sampler TurboMatrix-40 unit attached to a PERKIN ELMER™ Autosystem Gas Chromatography instrument. The parameters were set as follows:

| | | |
|---|---|---|
| Oven temperature | 80° | C. |
| Needle temperature | 100° | C. |
| Transfer temperature | 105° | C. |
| Cycle time | 60 | min |
| Thermostat time | 20 | min |
| Pressurization time | 3 | min |
| Injection time | 1 | min |
| Withdrawal time | 0.5 | min |

| | |
|---|---|
| Vial venting | on |

The parameters for the PERKIN ELMERT™ Autosystem Gas Chromatography were as follows:

| | |
|---|---|
| Temp. Program | 40° C. (held 2 min), Followed by 5° C./min rise to |
| | 200° C. (5 min), |
| Column | VARIAN ™ Chrompak capillary column WCOT (Wall |
| | Coated Open Tubular) Fused Silica 30 m × 0.53 mm. |
| Coating | CP WAX 52CB, DF = 1.0 μm. (Chemically bound |
| | Polyethylene glycol based polar columns). |
| Detector | FID (Flame Ionization Detector) 250° C. |

The concentrations of linalool and α-terpeniol measured by Head-space gas chromatography after 1 week and 2 weeks of cold storage (at 0° C.) and at room temperature storage (25° C.) are tabulated below for Comparative Example A and Example 1. The data represent the average of three replicates. Higher concentrations of linalool are associated with a sensory perception of overall well-rounded floral aroma. On the other hand, increasing level of α-terpeniol is indicative of an off-flavour.

TABLE 1
Concentration of linalool and α-terpeniol*

| | | Concentration | | Concentration (ppm) | |
|---|---|---|---|---|---|
| Storage | | (ppm) of linalool* | | of α-terpeniol | |
| Temp | Time | (Mean ± std dev) | | (Mean ± std dev) | |
| (° C.) | (weeks) | Ex A | Ex 1 | Ex A | Ex 1 |
| 0 | 1 | 2.26 ± 0.02 | 6.35 ± 0.01 | 1.65 ± 0.01 | 0.3 ± 0 |
| 0 | 2 | 1.45 ± 0.01 | 5.15 ± 0.01 | 1.8 ± 0.01 | 0.53 ± 0.01 |
| 25 | 1 | 2.17 ± 0.01 | 5.86 ± 0 | 1.79 ± 0.02 | 0.74 ± 0.01 |
| 25 | 2 | 1.42 ± 0.01 | 3.05 ± 0.01 | 1.97 ± 0.02 | 0.88 ± 0.01 |

*Concentration of linalool used at the start in all the experiments stated in the above table was 8 ppm, and that of α-terpeniol was zero.

It can be seen from the above table that the generation of off-flavours as indicated by the concentration of α-terpeniol is significantly less in a ready-to-drink beverage prepared by the process of the present invention (Example 1) as compared to the conventional process of Comparative Example A. It can be further seen that concentration of linalool, a key flavour ingredient is significantly higher in ready-to-drink tea beverage prepared by the process according to the present invention.

### Sensorial Data

The ready-to-drink tea beverage prepared by the process of the present invention (Example 1) and by the conventional process of the prior art (Comparative Example A) were subjected to evaluation by 8 trained panellists. Each panellist was asked to score tea for aroma, taste and overall impact on a scale of 1 to 10, 1 being the worst and 10 being the best. The panellists were also asked to choose the tea on the basis of overall preference. The results are tabulated below:

TABLE 2
Organoleptic properties

| Panellist | Aroma | | Taste | | Overall Impact | |
|---|---|---|---|---|---|---|
| Number | Ex A | Ex 1 | Ex A | Ex 1 | Ex A | Ex 1 |
| 1 | 5 | 7 | 5 | 7 | 5 | 7 |
| 2 | 3 | 8 | 3 | 8 | 3 | 8 |
| 3 | 6 | 8 | 6 | 7 | 5 | 7 |
| 4 | 4 | 7 | 5 | 7 | 4 | 7 |
| 5 | 4 | 7 | 4 | 8 | 4 | 7 |
| 6 | 6 | 7 | 6 | 7 | 5 | 7 |
| 7 | 9 | 8 | 9 | 8 | 8 | 7 |
| 8 | 4 | 6 | 5 | 7 | 6 | 7 |

From the above results, it is clear that the scores for aroma, taste and overall impact were significantly higher for the ready-to-drink tea beverage prepared with separately pasteurized acidulant and non-acidulant constituents as compared to the tea beverage where the pasteurization was carried out after mixing the constituents.

### Effect of Temperature of Constituents Prior to Mixing

The effect of temperature to which the constituents are cooled separately prior to mixing was investigated. The constituents were cooled to various temperatures prior to mixing. After mixing, the beverage was cooled to 25° C. and concentrations of linalool and α-terpeniol were measured within 8 hours of preparation of the beverage. The results are tabulated below.

TABLE 3
Effect of temperature

| Temperature of | Concentration (ppm) | Concentration (ppm) |
|---|---|---|
| constituents prior | of linalool | of α-terpeniol |
| to mixing (° C.) | (mean ± std dev) | (mean ± std dev) |
| 25 | 6.54 ± 0.01 | 0.33 ± 0.02 |
| 40 | 6.36 ± 0.01 | 0.33 ± 0.01 |
| 55 | 6.35 ± 0.01 | 0.34 ± 0.01 |
| 70 | 4.9 ± 0.01 | 0.74 ± 0.01 |
| 90 | 2.27 ± 0.01 | 2.00 ± 0.02 |

It can be seen that the constituents need to be cooled separately to temperature less than 75° C. prior to mixing. Better results are obtained if the constituents are cooled separately to temperature less than 55° C., and further improvement is seen if the constituents are cooled below 40° C.

It will be appreciated that the process of the present invention as illustrated above provides a ready-to-drink tea beverage that retains aroma and has a relatively long shelf life with substantially reduced generation of off-flavours.

1. A process for preparation of a ready-to-drink tea beverage, wherein the beverage comprises an aqueous acidulant constituent having pH less than 4 and an aqueous non-acidulant constituent having pH greater than 4, the aqueous non-acidulant constituent comprises a flavourant, and at least one of the constituents comprises cold-soluble tea solids, and the process comprises the steps of:
a. subjecting each of the constituents separately to pasteurization;
b. cooling each of the constituents separately to a temperature less than 75° C.; and
c. mixing the constituents.

2. A process as claimed in claim 1 wherein said flavourant is an acid-degradable flavourant.

3. A process as claimed in claim 2 wherein said acid-degradable flavourant comprises terpene alcohol.

4. A process as claimed in claim 3 wherein said terpene alcohol is selected from the group consisting of linalool, nerol, geraniol or a mixture thereof.

5. A process as claimed in claim 4 wherein said terpene alcohol is linalool.

6. A process as claimed in claim 1 wherein said aqueous acidulant constituent comprises an acid or a salt or ester thereof that has pKa less than 5.

7. A process as claimed in claim 6 wherein said acid is selected from formic acid, acetic acid, citric acid, ascorbic acid, fumaric acid, succinic acid, lactic acid, malic acid, phosphoric acid, L-tartaric acid or a mixture thereof.

8. A process as claimed in claim 7 wherein said acid is citric acid.

9. A ready-to-drink tea beverage obtained or obtainable by a process according to claim 1.
